(19) United States
(12) Patent Application Publication
(10) Pub. No.: US 2017/0221113 A1
(43) Pub. Date: Aug. 3, 2017

(54) WARNING DEVICE, PROGRAM, NON-TRANSITORY RECORDING MEDIUM AND METHOD

(71) Applicant: Rakuten, Inc., Tokyo (JP)

(72) Inventor: Jun KATAKAWA, Tokyo (JP)

(73) Assignee: Rakuten, Inc., Tokyo (JP)

(21) Appl. No.: 15/514,845

(22) PCT Filed: Oct. 30, 2014
(86) PCT No.: PCT/JP2014/078903

§ 371 Date: Mar. 28, 2017

(51) Int. Cl. G06Q 30/06; G06F 13/00; G06Q 50/00; G06Q 30/02; G06Q 40/04

(52) U.S. Cl. CPC G06Q 30/06; G06Q 30/0206; G06Q 40/04; G06Q 50/00; G06F 13/00; G06Q 30/02

(57) ABSTRACT

A warning device (100) includes an extractor (140) that extracts a related text relevant to a price of a trading object from a web page for trading the trading object, a determiner (150) that determines whether or not there is a contradiction between the extracted related text and the changed price, and a warner (160) that warns when the determiner determines that there is the contradiction.

### TECHNICAL FIELD

The present disclosure relates to warning device, program, non-transitory recording medium, and method.

### BACKGROUND ART

Conventionally, a method of releasing, after a boarding fee is reduced based on a boarding percentage, information on the reduction of a boarding fee on a web page is known (see, for example, Patent Literature 1).

### CITATION LIST

### Patent Literature

Patent Literature 1: Unexamined Japanese Patent Application Kokai Publication No. 2003-216985

### SUMMARY OF INVENTION

### Technical Problem

According to the method disclosed in Patent Literature 1, the details of such a web page is mechanically updated. Conversely, in an electronic market for trading commercial products, and the like, when a change in trading price is registered, the changed trading price is often mechanically reflected on a web page for trading the commercial products, and the like. In addition, a web page often contains contents manually created and edited in order to induce a person who is viewing the web page to increase purchase motivation. Accordingly, a part of the web page is mechanically updated in accordance with a change in trading price, but sometimes a store needs to edit the other part of the web page by themselves.

In such a case, a description in the contents of the web page created by the store before the price change containing text relevant to the previous trading price, is sometimes accidently left as is without any correction in the updated contents, or edited although with the inadvertant inclusion of a typographical error.

Because of such a forgotten correction and a presence of an error, a part of the web page mechanically updated and a part edited manually may have a contradiction. According to the method of mechanically updating the contents as disclosed in Patent Literature 1, no warning is given for the contradiction of the details described in the updated web page.

The present disclosure has been made in view of the aforementioned technical problems, and an objective of the present disclosure is to provide a warning device, a program, a non-transitory recording medium, and a method which give a warning for a contradiction caused between a registered trading price and the details of contents described in a web page for trading.

### Solution to Problem

In order to accomplish the above objective, a warning device according to a first aspect of the present disclosure comprises:

an extractor that extracts a related text relevant to a price of a trading object from a web page for trading the trading object when the trading price of the trading object is changed;

a determiner that determines whether or not there is a contradiction between the extracted related text and the changed price; and

a warner that warns when the determiner determines that there is the contradiction.

The warning device according to the first aspect further includes a specifier that specifies the related text with a frequency of replacement or deletion from the web page for trading in an electronic market where a large number of stores are in business, the replacement or deletion frequency being equal to or larger than a predetermined value,

in where the warner warns when the specified related text is displayed on the web page.

in which the warner warns when the specified related text is displayed on the web page.

In the warning device according to the first aspect, the related text is further relevant to an applied time period at which the changed price is being applied to the trading;

the determiner further determines whether or not there is a contradiction in a content displayed on the web page based on a time and date at which the price was changed and the applied time period; and

the warner warns when the determiner determines that there is the contradiction.

In the warning device according to the first aspect, the related text is a text indicating the price previous to the change, a text indicating difference between the price previous to the change and the changed price, or a text implying the price previous to the change;

the warning device further comprises an information memory that stores the price of the trading object previous to the change; and

the determiner determines, based on the price previous to the change specified on a basis of the related text, and the stored price previous to the change, whether or not there is the contradiction.

In the warning device according to the first aspect, the extractor extracts the related text from an image displayed on the web page.

In the warning device according to the first aspect, wherein the trading price includes the price of the trading object, and a delivery charge for the trading object.

In order to accomplish the above objective, a program according to a second aspect of the present disclosure causes a computer to function as:

an extractor that extracts a related text relevant to a price of a trading object from a web page for trading the trading object when the trading price of the trading object is changed;

a determiner that determines whether or not there is a contradiction between the extracted related text and the changed price; and

a warner that warns when the determiner determines that there is the contradiction.

In order to accomplish the above objective, a non-transitory computer-readable recording medium according to a third aspect of the present disclosure has recorded therein a program that causes a computer to function as:

an extractor that extracts a related text relevant to a price of a trading object from a web page for trading the trading object when the trading price of the trading object is changed;

a determiner that determines whether or not there is a contradiction between the extracted related text and the changed price; and

a warner that warns when the determiner determines that there is the contradiction.

In order to accomplish the above objective, a warning method according to a fourth aspect of the present disclosure includes:

an extracting step of extracting a related text relevant to a price of a trading object from a web page for trading the trading object when the trading price of the trading object is changed;

a determining step of determining whether or not there is a contradiction between the extracted related text and the changed price; and

a warning prompting step of warning when the determiner determines that there is the contradiction.

### Advantageous Effects of Invention

According to the warning device, program, non-transitory recording medium and method, a warning can be given for a contradiction caused in the described contents of a web page.

### BRIEF DESCRIPTION OF DRAWINGS

FIG. 1 is a system structural diagram illustrating an example structure of a warning system according to a first embodiment;

FIG. 2 is a diagram illustrating an example trading page displayed by a terminal device of the first embodiment;

FIG. 3 is a hardware structural diagram illustrating an example warning device;

FIG. 4 is a flowchart illustrating an example first warning process executed by the warning device;

FIG. 5 is a functional block diagram illustrating an example function of the warning device according to the first embodiment;

FIG. 6 is a diagram illustrating an example trading price table stored in the warning device of the first embodiment;

FIG. 7 is a diagram illustrating an example trading page to which a warning message is added;

FIG. 8 is a flowchart illustrating an example second warning process executed by the warning device;

FIG. 9 is a functional block diagram illustrating an example function of a warning device according to a second embodiment;

FIG. 10 is a diagram illustrating an example trading price table stored in the warning device according to the second embodiment;

FIG. 11 is a diagram illustrating an example trading page displayed by a terminal device of the second embodiment;

FIG. 12 is a diagram illustrating an example category hierarchical layer;

FIG. 13 is a diagram illustrating an example category hierarchical layer table stored in the warning device;

FIG. 14 is a diagram illustrating an example trading page displayed by a terminal device according to a third embodiment; and

FIG. 15 is a flowchart illustrating an example third warning process executed by the warning device.

### DESCRIPTION OF EMBODIMENTS

Embodiments of the present disclosure will be explained below with reference to the accompanying figures.

### First Embodiment

A warning system 1 according to a first embodiment of the present disclosure is a system that gives a warning for an error or a contradiction relevant to the contents of a web page for trading (hereinafter, referred to as a trading page). In this embodiment, an explanation will be given of an example case in which trading is a mercantile trading in an electronic market where a large number of stores are in business.

In this embodiment, an explanation will be given of an example case in which commercial products are objects for trading, but may also be services. In this specification, a commercial product is not limited to any particular one as long as such a commercial product is an object for trading regardless of characteristics of distribution, substitutability, and mass-production possibility. In addition, a commercial product may be an intangible object like electricity. Still further, a commercial product may be an immovable object, such as a condominium unit, or land. Yet still further, a commercial product may be an object for indirect mercantile trading like valuable stock certificates. In this embodiment, a service includes an object for mercantile trading independently like a labor service or a benefit carried out for somebody else, but is not limited to such an example. In this embodiment, an explanation will be given of an example case in trading is a sale, but may be a voluntary assignment, a lease, a provision through an electric communication network, an export or an import.

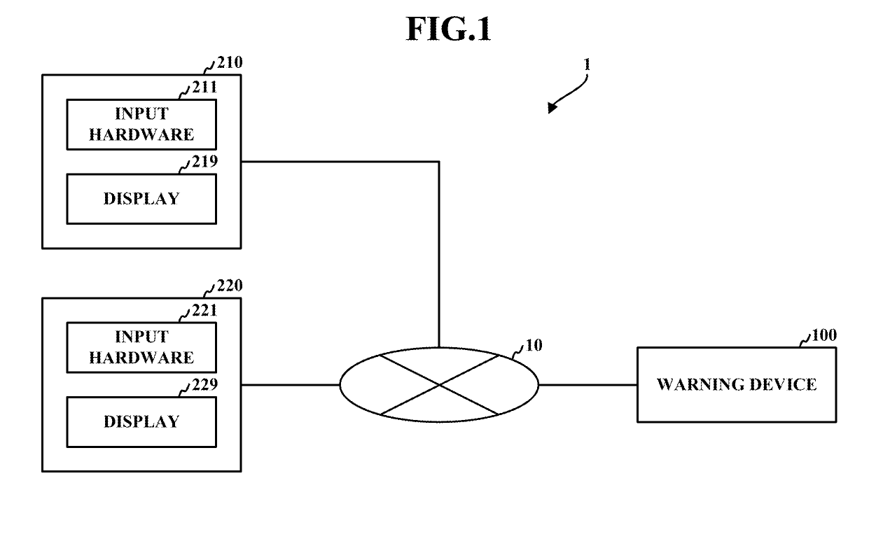

The warning system 1 illustrated in FIG. 1 includes a warning device 100 and terminal devices 210 and 220 communicably connected to one another via a computer communication network 10 (hereinafter, simply referred to as a communication network 10).

Before explaining the warning device 100, an explanation will be given of the terminal devices 210 and 220. The terminal device 210 is a personal computer that includes input hardware 211, such as a keyboard and a mouse, and a display 219 like a Liquid Crystal Display (LCD). The terminal device 220 includes input hardware 221 and a display 229 which have the same structures as those of the input hardware 211 and the display 219 of the terminal device 210. The terminal devices 210 and 220 employ the same structure, and perform the same operation. Hence, the following explanation will be given mainly of the terminal device 210.

In this embodiment, an explanation will be given of an example case in which the terminal device 210 is utilized by a user of a store A selling a commercial product X (hereinafter, referred to as a seller), and the terminal device 220 is utilized by a customer. In this embodiment, an explanation thereof will be given based on an example case in which the seller who utilizes the terminal device 210 is selling the commercial product X that is “wine”, was initially selling the wine at 1000 yen, but reduced the price to 500 yen (that is, 50% OFF) since the sales of such a wine are slow.

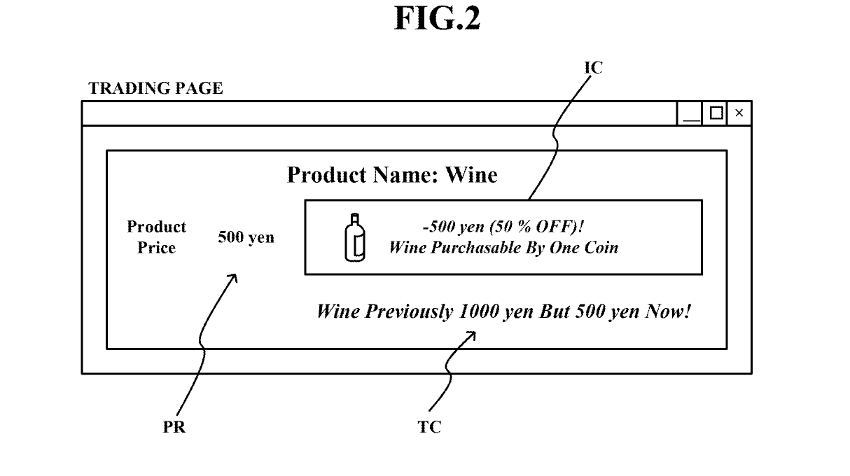

The seller or the customer operates the terminal device 210 or 220, and causes the terminal device 210 or 220 to send a request of sending a trading page. The purpose of this is to check the contents of a commercial product trading page for sale or purchase. A trading page which is replied from the warning device 100 contains, as illustrated in FIG. 2, a price display part PR, a text contents display part TC, and an image contents display part IC.

The price display part PR displays a commercial product price, the text contents display part TC displays a text that explains the commercial product and how to trade the commercial product, and the image contents display part IC displays an image that explains the commercial product and how to trade the commercial product. Images that are texts “50% OFF” and “−500 yen” indicating how much the changed price is reduced from the previous price are posted on the image contents display part IC illustrated in FIG. 2. In addition, a text “one coin” that suggests or implies the changed price “500 yen” is displayed in the image contents display part IC. The term one coin is word that suggests or implies that a commercial product is purchasable with a generally circulated coin which in Japan has the maximum value of a “500 yen” coin.

In this case, an explanation will be given of this embodiment based on an example case in which the seller at the store A is attempting to increase the price of the commercial product X by 100 yen since the availability of such commercial products is decreasing. First, the seller operates the terminal device 210, and carries out a user authentication by causing the terminal device 210 to send information to identify the store (hereinafter, referred to as a store ID) “S01” and a password. When the user authentication is successful, the input hardware 211 of the terminal device 210 accepts inputting of information to identify the commercial product that is “wine” (hereinafter, referred to as a commercial product ID) “G01”, and information on a commercial product price after the change (hereinafter, referred to as a changed price) “¥ 600” in accordance with the operation given by the seller.

Subsequently, the terminal device 210 sends information indicating the commercial product ID and information indicating the changed price to the warning device 100. The warning device 100 updates the commercial product price to be displayed in the price display part PR of the trading page identified by the commercial product ID based on the received information. However, the warning device 100 does not update the contents displayed in the text contents display part TC and the contents displayed in the image contents display part IC based on the information indicating the changed price.

When the warning device 100 receives the contents updated by the terminal device 210 that has been operated by the seller, the warning device 100 updates the contents to be displayed in the text contents display part TC and the contents to be displayed in the image contents display part IC based on the received contents. Hence, the commercial product price displayed in the price display part PR and the contents displayed in the text contents display part TC or in the image contents display part IC sometimes have a contradiction.

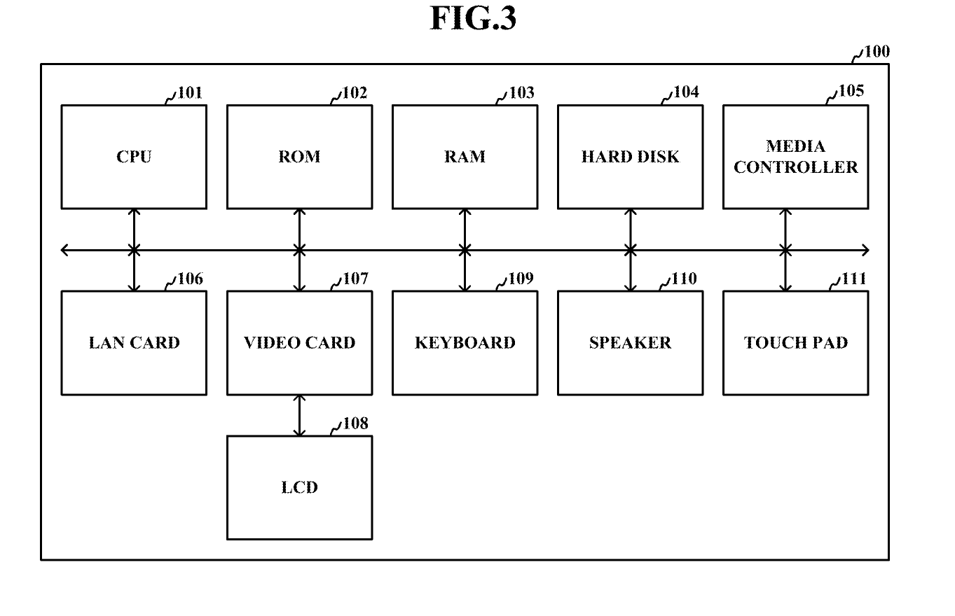

The warning device 100 is constructed by a server device illustrated in FIG. 3. The warning device 100 includes a Central Processing Unit (CPU) 101, a Read Only Memory (ROM) 102, a Random Access Memory (RAM) 103, a hard disk 104, a media controller 105, a Local Area Network (LAN) card 106, a video card 107, a Liquid Crystal Display (LCD) 108, a keyboard 109, a speaker 110, and a touch pad 111.

The CPU 101 runs a program in accordance with another program stored in the ROM 102 or in the hard disk 104, thereby controlling the entire warning device 100. The RAM 103 is a work memory that temporarily stores data to be processed at the time of running the program by the CPU 101. The hard disk 104 is an information memory that stores various data.

The media controller 105 reads various data and programs from a non-transitory recording medium, such as a flash memory, a Compact Disc (CD), a Digital Versatile Disc (DVD), and a Blu-ray (registered trademark) disc.

The LAN card 106 exchanges data between the terminal devices 210 and 220 connected with each other via the communication network 10. The keyboard 109 and the touch pad 111 input signals in accordance with the operation given by the user.

The video card 107 draws (that is, renders) an image based on digital signals output by the CPU 101, and outputs image signals that represent the drawn image. The LCD 108 displays an image in accordance with image signals output by the video card 107. The speaker 110 outputs sounds based on signals output by the CPU 101.

Next, a function of the warning device 100 will be explained.

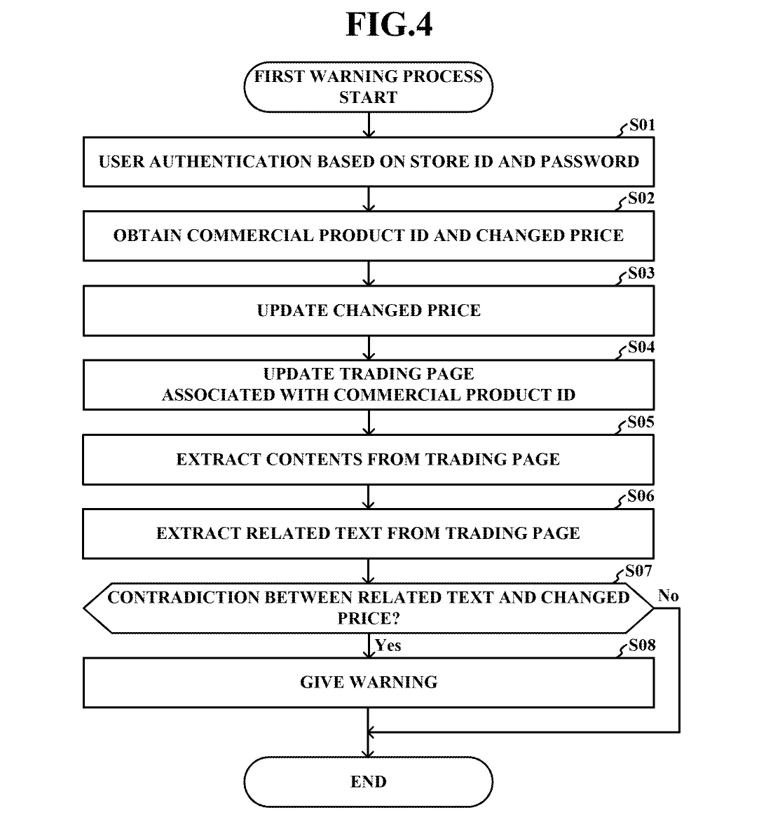

The CPU 101 executes a first warning process illustrated in FIG. 4. The first warning process is a process of giving a warning for a contradiction existing in the contents posted on the trading page.

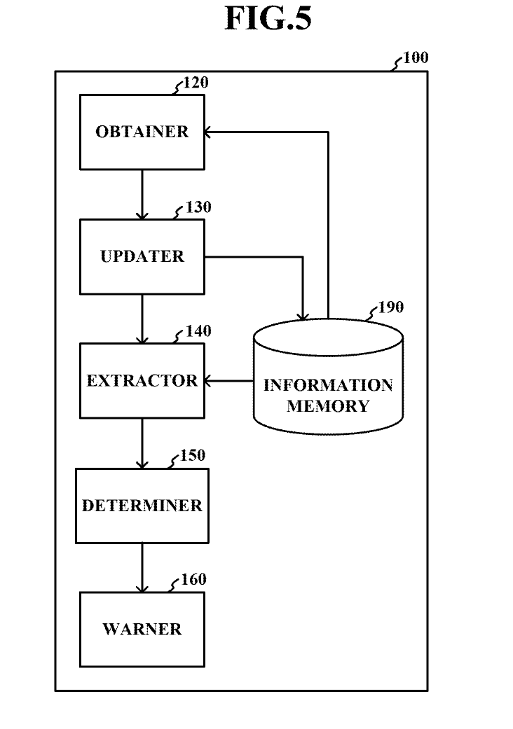

By executing this process, the CPU 101 functions as an obtainer 120, an updater 130, an extractor 140, a determiner 150, and a warner 160 illustrated in FIG. 5. In addition, the hard disk 104 illustrated in FIG. 3 works together with the CPU 101 to function as an information memory 190. Before giving an explanation of the obtainer 120, the updater 130, the extractor 140, the determiner 150, and the warner 160, an explanation will be given of the information memory 190.

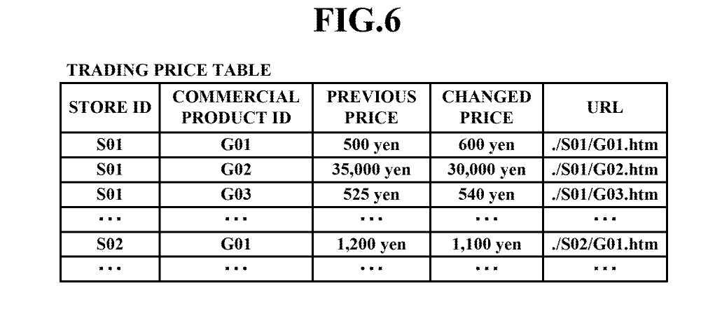

The information memory 190 stores a trading price table and multiple trading pages as illustrated in FIG. 6. This is to allow the warning device 100 to determine the consistency between a trading price and the contents of the trading page. Hence, the store ID to identify the store, the commercial product ID to identify a commercial product, information on a previous price, information on the changed price, and a URL of the trading page of the store for the commercial product are stored in the trading price table in association with one another. Multiple store IDs, commercial product IDs, pieces of information on the previous price, and pieces of information on the change price are held in this case.

Next, returning to FIG. 5, an explanation will be given of the obtainer 120, the updater 130, the extractor 140, the determiner 150, and the warner 160 in sequence. The obtainer 120 obtains information on the changed price from the LAN card 106, and obtains a trading page for the commercial product with a changed price from the information memory 190. The updater 130 updates the trading page so as to post the changed price thereon. The extractor 140 extracts a related text relevant to the trading price from the contents of the trading page.

The related text is not limited to any particular one as long as such a text is relevant to the price. For example, the related text includes a text that shows how much the changed price is reduced or increased relative to the previous price, such as “−500 yen”, “+500 yen”, or “50% OFF”. In addition, for example, the related text includes a text that directly shows the previous or changed price. Still further, the related text includes a text that suggests or implies the previous or changed price like “one coin”. The term “one coin” is a related text which suggests or implies that the price is equal to or lower than 500 yen in Japan.

The determiner 150 determines whether or not a contradiction is present between the related text extracted by the extractor 140 and at least one of the previous prices and the changed price. When the determiner 150 determines that there is a contradiction, the warner 160 outputs a warning message.

Returning to FIG. 4 now, an explanation will be given of the first warning process that realizes each function illustrated in FIG. 5. When the LAN card 106 receives the store ID and the password from the terminal device 210, the CPU 101 starts executing the first warning process.

When the execution of the first warning process starts, the obtainer 120 obtains the store ID and the password from the LAN card 106, obtains the password stored in the information memory 190 beforehand in association with the store ID, and executes (step S01) the user authentication.

The obtainer 120 ends the execution of the first warning process when the user authentication is unsuccessful, and obtains (step S02) the commercial product ID and information on the changed price from the LAN card 106 when the user authentication is successful.

Next, the updater 103 updates information on the previous price contained in the trading price table in association with the obtained commercial product ID by information on the changed price associated with the commercial product ID. This is because the price has been changed. Subsequently, the updater 130 updates (step S03) the information on the changed price associated with the commercial product ID by the obtained information on the changed price.

Next, the updater 130 obtains a URL contained in the trading price table in association with the commercial product ID, and updates (step S04) the price of the commercial product described in the price display part of the trading page that has the obtained URL by the changed price indicated by the obtained information.

Next, the extractor 140 suspends the process until either earlier time of a time and date by a predetermined time after a time and date at which the information on the changed price has been obtained (hereinafter, referred to as price changed time and date) or a time and date (contents received time and date) at which the LAN card 106 in FIG. 3 has received the edited contents from the terminal device 210.

When the time and date by the predetermined time after the price changed time and date comes earlier than the contents received time and date, the extractor 140 restarts the process from step S05. Conversely, when the contents received time and date comes earlier, the extractor 104 restarts the process from step S05 after the obtainer 120 obtains the edited contents from the LAN card 106, and the updater 130 updates the contents in the text contents display part TC or the image contents display part IC of the trading page by the edited contents.

When restarting the process, the extractor 140 obtains (step S05) the text contents and the image contents from the text contents display part TC and the image contents display part IC of the trading page, respectively.

In this case, the information memory 190 stores, in association with each other, a marking character or a marking text that will be a reference when the related text is extracted and range information indicating within which range the related text is normally posted on the trading page with reference to the marking character or the marking text. Multiple marking characters or texts and pieces of range information are held in this case.

For example, as for the related text that shows how much the changed price is reduced or increased relative to the previous price like “−500 yen”, the information memory 190 stores marking texts “−” and “yen”, and the range information indicating that the range between the marking texts “−” and “yen” is the related text. In addition, for example, as for the related text, such as “50% OFF” or “500 yen”, the information memory 190 stores the marking texts “% OFF” and “yen”, and the range information indicating that the range where forward numbers are arranged side by side from the marking text is the related text. Still further, as for the related text like “one coin”, the information memory 190 stores the marking text “one coin” and the range information indicating that the marking text itself is the related text.

After step S05, the extractor 140 extracts the text contents from the image contents by applying, for example, Optical Character Recognition (OCR). Subsequently, the extractor 140 extracts (step S06), from the text contents extracted from the text contents display part TC and the text contents extracted from the image contents, the related text based on the marking text and the range information both stored in the information memory 190.

More specifically, the extractor 140 extracts the related texts that are “1000 yen” and “500 yen” from the text contents extracted from the text contents display part, and the related texts that are “−500 yen”, “50% OFF” and “one coin” from the text contents extracted from the image contents.

Subsequently, the determiner 150 determines (step S07) whether or not there is a contradiction between the related text extracted by the extractor 140 and at least one of the previous prices and the changed price. More specifically, the determiner 150 obtains the previous price “¥500” and the changed price “¥600” contained in the trading price table in association with the store ID “S01” and the commercial product ID “G01” obtained by the obtainer 120. Next, the determiner 150 calculates the amount of difference “+¥100” between the previous price “¥500” and the changed price “¥600”. Subsequently, the determiner 150 unifies the notation of the related text “−500 yen” and that of the amount of difference “+¥100”, and determines that there is a contradiction since the related text “−¥500” and the amount of difference “+¥100” are different from each other.

Note that the determiner 150 may specify the previous price “¥100” based on the changed price “¥600” and the related text “−500 yen”, and may determine that there is a contradiction since the specified previous price “¥100” and the previous price “¥500” contained in the trading price table are different from each other.

Likewise, the determiner 150 calculates a change rate “120%” from the previous price “¥500” to the changed price “¥600”, and unifies the notation of the related text “50% OFF” and that of the price change rate “120%”. Subsequently, the determiner 150 determines that there is a contradiction regarding the related text “50% OFF” since the related text “−50%” and the price change rate “120%” are different from each other.

Note that the determiner 150 may specify the previous price “¥1200” based on the changed price “¥600” and the related text “50% OFF”, and may determine that there is a contradiction since the specified previous price “¥1200” is different from the previous price “¥500” contained in the trading price table.

In addition, the determiner 150 performs a syntactical analysis on a sentence “wine purchasable by one coin” that contains the related text “one coin”, and determines that the text “one coin” indicates not the previous price but the changed price. In contrast, when, for example, a sentence is “wine previously purchasable by one coin”, the text “one coin” indicates the previous price. Accordingly, since the changed price “¥600” is higher than the price that is equal to or lower than “¥500” indicated by the related text, the determiner 150 determines that there is a contradiction regarding the related text “one coin”.

Still further, the determiner 150 performs a syntactical analysis on a sentence “wine previously 1000 yen, but now 500 yen” that contains the related texts “1000 yen” and “500 yen”, and determines that the related text “1000 yen” indicates the previous price, and the related text “500 yen” indicates the changed price. Hence, the determiner 150 determines that there is a contradiction since the previous price “¥500” in the trading price table and in the trading page is different from the previous price “¥1000” indicated by the related text. In addition, the determiner 150 also determines that there is a contradiction since the changed price “¥600” in the trading price table and in the trading page is different from the changed price “¥500” indicated by the related text.

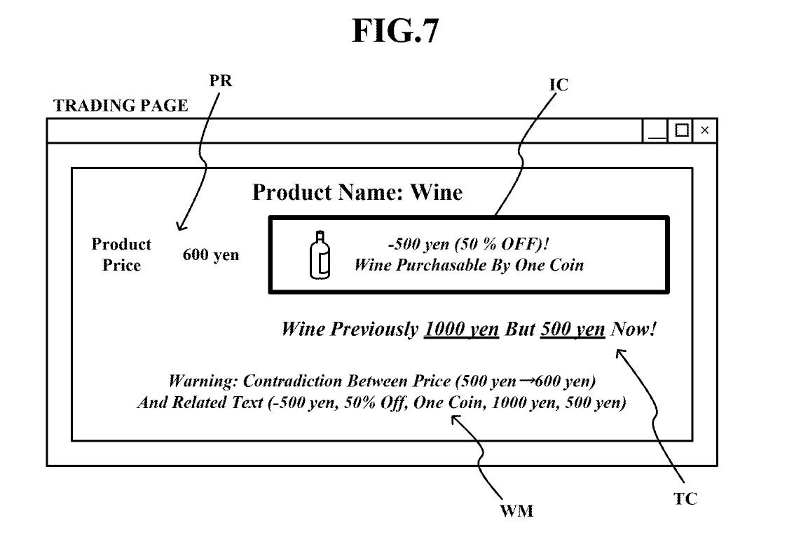

Subsequently, the warning promoter 160 creates a warning message that gives a warning for a contradiction between the related text posted on the trading page with the changed price and at least one of the previous prices and the changed price. Next, the warning promoter 160 adds an underline to the related text containing the contradiction or performs trimming on the image contents that contain such a related text as illustrated in FIG. 7, thereby emphasizing and displaying, in the trading page, the related text and the contents containing the related text. Subsequently, the warning promoter 160 adds the created warning message to the trading page, and outputs, to the LAN card 106, the trading page which has a destination that is the terminal device 210, thereby giving a warning (step S08). Next, the warning promoter 160 ends the execution of the first warning process.

Next, the LAN card 106 sends the trading page to which the warning message is added to the terminal device 210, and the terminal device 210 displays the received trading page on the display 219.

Subsequently, the seller who has checked the warning message in the trading page operates the input hardware 211 of the terminal device 210, and edits the contents of the trading page so as to eliminate the contradiction. The terminal device 210 edits the contents in accordance with the operation given by the seller, and sends the edited contents to the warning device 100.

The warning device 100 executes again the first warning process in FIG. 4 from step S05 to step S08 after updating the contents in the text contents display part TC and the image contents display part IC in the trading page by the edited contents upon receiving the edited contents. The purpose of this is to give a warning to the seller when there is a contradiction between the edited contents and at least one of the previous prices and the changed price.

According to this structure, the warning device 100 extracts the related text relevant to the price from the trading page, and gives a warning when a contradiction is present between the extracted related text and the price. Hence, an occurrence of a contradiction between the price of the commercial product to be traded through the trading page and the other contents described in the trading page can be suppressed.

### First Modified Example of First Embodiment

In the first embodiment, the explanation was given of an example case in which the trading page has the image contents display part IC where the image is displayed, and the extractor 140 in FIG. 5 extracts the related text from the still image displayed in the image contents display part IC by applying OCR. However, the present disclosure is not limited to this case, and the trading page may have a video-picture-contents display part that displays a video picture, and the extractor 140 may extract the related text by applying OCR for each frame that constructs the video picture. In addition, the trading page may output sounds, and the extractor 140 may extract the related text from a text that represents the contents of sounds extracted by a sound recognition process.

### Second Modified Example of First Embodiment

In the first embodiment and the first modified example thereof, the explanation was given of an example case in which the warner 160 in FIG. 5 adds the warning message to the trading page, but the present disclosure is not limited to such a case, and warning sounds may be added to the trading page.

### Third Modified Example of First Embodiment

In the first embodiment and the several modified examples thereof, the explanation was given of an example case in which the related text includes a text that is “one coin” suggesting a price normally equal to or lower than 500 yen in Japan, but the present disclosure is not limited to this case. For example, the text may be “Yukichi” which suggests a price of 10000 yen normally in Japan, and which stands for a person Yukichi Fukuzawa who has a resemblance printed on a 10000 yen bill circulated in Japan. Likewise, the text may be “Benjamin” which suggests a price of US 100 dollars normally in America, and which stands for a person Benjamin Franklin who has a resemblance printed on a US 100 dollar bill circulated in America. Still further, the text may be “C-bill” or “C-note” suggesting a price of US 100 dollars.

### Fourth Modified Example of First Embodiment

In the first embodiment and the several modified examples thereof, the explanation was given of an example case in which the price necessary for trading (that is, trading price) is a price of a commercial product (that is, commercial product price), but the present disclosure is not limited to this case. For example, the trading price may be a delivery charge of a commercial product, may be a total price including the delivery charge and the commercial product price, or may be a price including a tax, such as a sales tax or an added-value tax. Hence, the related text may be a text relevant to the delivery charge, such as “free shipping” or “free mail service via courier”.

### Fifth Modified Example of First Embodiment

In the first embodiment and the several modified examples thereof, the explanation was given of an example case in which, when obtaining information about the changed price, the warning device 100 executes the first warning process from step S01 to step S08, but the present disclosure is not limited to this case. The warning device 100 may execute the first warning process from step S01 to step S04 when obtaining the information on the changed price to update the trading page with the changed price and the trading price table stored in the information memory 190, and then end the process. The purpose of this is to give a time for the seller to operate the terminal device 210 and to edit the contents displayed in the text contents display part TC and in the image contents display part IC. Subsequently, when a predetermined time, for example, 2:00 AM comes, the warning device 100 may execute the first warning process from step S04 to step S08 for all of or a part of the trading page stored in the information memory 190.

According to such a structure, when the seller edits the contents of the trading page to the contents that have matched details with the changed price, the warning process in step S08 is not necessary to be executed. Accordingly, in comparison with a case in which, when obtaining the information on the changed price, the warning device 100 executes the first warning process from step S01 to step S08, the amount of calculation by the warning device 100 can be reduced.

### Second Embodiment

A warning system 1 according to a second embodiment of the present disclosure gives a warning to a store that utilizes the trading page on which the related text with a frequency of replacement or deletion (hereinafter, deletion frequency) equal to or greater than a predetermined value is posted in the electronic market where a large number of stores in business.

The warning system according to this embodiment employs substantially same structure as that of the warning system 1 explained in the first embodiment and in the several modified examples, has substantially the same operations, and has substantially the same functions. Hence, a difference between the warning system 1 of this embodiment and the warning system 1 of the first embodiment and the several modified examples will be explained.

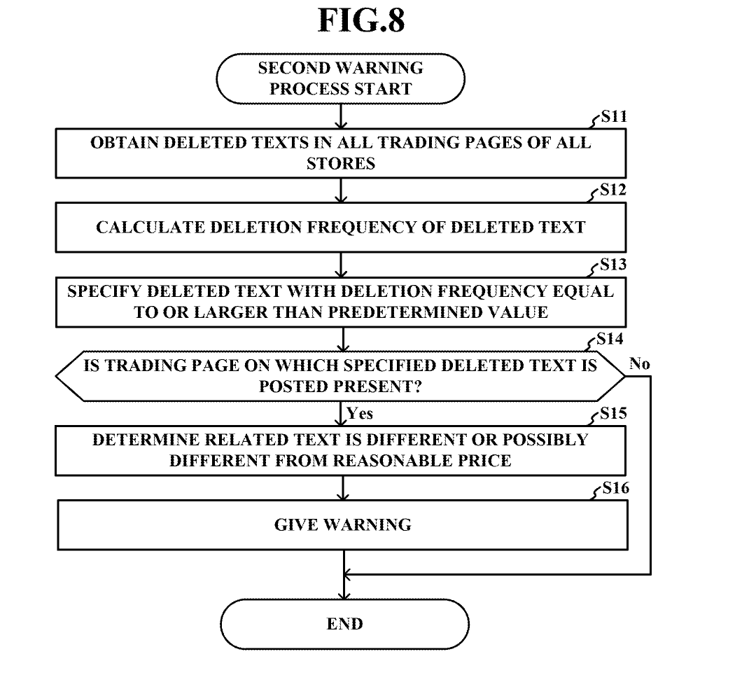

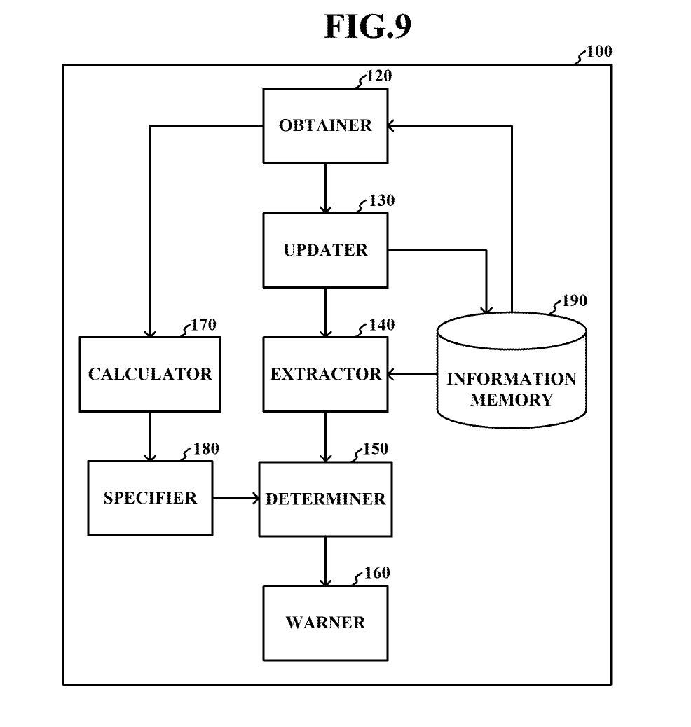

In this embodiment, the CPU 101 in FIG. 3 further executes a second warning process illustrated in FIG. 8. By executing this process, the CPU 101 functions as the obtainer 120, the updater 130, the extractor 140, the determiner 150, the warner 160, and the information memory 190 already explained in the first embodiment, and further a calculator 170 and a specifier 180 are both illustrated in FIG. 9.

The calculator 170 calculates a deletion frequency for the deleted or replaced related text (hereinafter, referred to as deleted text), and the specifier 180 specifies the deleted text that has the deletion frequency equal to or greater than the predetermined value, and the warner 160 gives a warning to a store that utilizes the trading page on which the specified deleted text is posted.

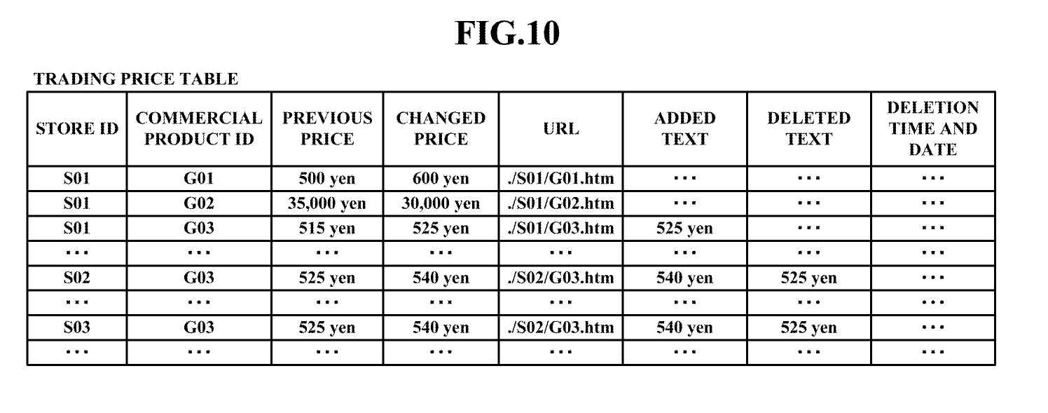

In this embodiment, the information memory 190 stores a trading price table as illustrated in FIG. 10. As illustrated in FIG. 10, a related text added to the trading page or replaced therefrom (hereinafter, referred to as added text), the deleted text deleted or replaced from the trading page, and information on a time and date at which the deleted text is deleted or replaced (hereinafter, referred to as deletion time and date) are contained in the trading price table in association with the store ID, the commercial product ID, and the URL of the trading page, and the like. Multiple added texts, deleted texts, and pieces of information on the deletion time and date are contained in this case.

In this case, the store IDs from “S01” to “S03” are associated with the commercial product ID “G03” in the trading price table. This is because the stores A to C identified by the store IDs “S01” to “S03”, respectively, are selling a commercial product Z that is identified by the commercial product ID “G03”.

In this embodiment, an explanation will be given of an example case in which the tax rate defined by a law was “5%”, and the stores A to C were selling the commercial product Z at a tax inclusive price “525 yen” obtained by adding the tax amount to the commercial product price “500 yen”.

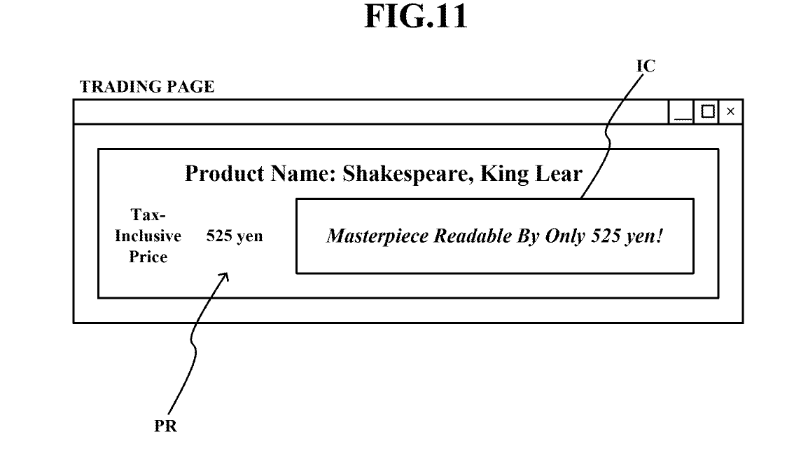

Hence, the stores A to C utilized a trading page as illustrated in FIG. 11 and having the tax-inclusive price “525 yen” displayed in the price display part PR.

Subsequently, an explanation will be given of an example case in which a law is enforced which changes the tax rate from “5%” to “8%”, and the sellers of the stores B and C change the tax-inclusive price from “525 yen” to “540 yen”, but the seller of the store A is failing to change the price.

Hence, the sellers from the stores B and C operate the respective terminal devices 210, and the respective terminal devices 210 send the store IDs “S02” and “S03”, the commercial product ID “G03”, and information on the changed tax-inclusive price to the warning device 100 in accordance with the given operation. In addition, the respective terminal devices 210 edit the contents displayed in the image contents display part IC to the contents indicating the tax-inclusive price “540 yen” after the change of the tax rate in accordance with the given operation, and sends the edited contents to the warning device 100.

The warning device 100 executes the first warning process in FIG. 4 from step S01 to step S03 based on the information received from the terminal device 210 and the edited contents. Next, the updater 130 in FIG. 9 updates (step S04) the commercial product price described in the price display part PR of the trading page with the URL associated with the commercial product ID “G03” in the trading price table by the tax-inclusive price “540 yen” after the tax rate change.

Subsequently, after obtaining the image contents not edited yet from the image contents display part IC of the trading page, the extractor 140 obtains the related text “525 yen” from the image contents not edited yet.

Next, the updater 130 updates the contents of the image contents display part IC by the edited contents. Subsequently, the extractor 140 obtains (step S05) the edited contents from the updated trading page, and extracts (step S06) the related text “540 yen” from the edited contents.

Next, the updater 130 specifies that the added text is the related text “540 yen” not extracted from the contents not edited yet among the related texts extracted from the edited contents. Conversely, the updater 130 specifies that the deleted text is the related text “525 yen” not extracted from the edited contents among the related texts extracted from the contents not yet edited. Subsequently, the updater 130 obtains the current time and date from, for example, an Operating System (OS), and sets the obtained time and date as the deletion time and date.

Next, the updater 130 stores the added text “540 yen”, the deleted text “525 yen”, and the information on the deletion time and date in the trading price table in association with the store IDs “S02” and “S03”, and the commercial product ID “G03”.

Thereafter, the warning device 100 executes the processes in step S07 and S08, and when the trading page contains any contradiction, the warning device gives a warning to the stores B and C, and then ends the process execution.

When a predefined time has come, the CPU 101 in FIG. 3 starts executing the second warning process illustrated in FIG. 8. When the second warning process starts, the obtainer 120 in FIG. 9 obtains the current time and date from the OS. Next, the obtainer 120 obtains (step S11) all deleted texts contained in the trading price table in order to obtain the respective deleted or replaced deleted text from all trading pages of all stores within a time period between a predetermined time before the obtained time and date, and such obtained time and date.

Next, the calculator 170 classifies the obtained deleted texts into multiple classes based on the contents indicated by the deleted text. For example, the calculator 170 classifies the deleted texts “525 yen” and “¥525” into the same group. Subsequently, the calculator 170 counts, group by group, the number of deleted texts classified into the groups, and calculates (step S12) the deletion frequency that is a value obtained by dividing the counted value by the total number of all trading pages of all stores.

Next, the specifier 180 reads a predetermined value Th stored in the information memory 190 beforehand. Subsequently, the specifier 180 specifies (step S13) the group that has a larger deletion frequency than the predetermined value Th, and specifies the deleted text classified into the specified group. Note that the appropriate predetermined value Th can be defined by a person skilled in the art by experimental trial.

Next, the determiner 150 searches a record having any deleted text specified by the specifier 180 (hereinafter, referred to as a specified text) and contained as the added text from the trading price table, and obtains the URL contained in the obtained record. The purpose of this is to search (step S14) the URL of the trading page on which the specified text is posted from the trading table.

Subsequently, the determiner 150 determines (step S15) whether or not there is a trading page (hereinafter, referred to as a warning necessary page) on which the specified text that is different or possibly different from a reasonable price in the electronic market is posted based on whether or not the URL is obtainable. In this embodiment, an explanation will be given of an example case in which the specified text that is “525 yen” is specified, the URL of the trading page of the store A on which “525 yen” is posted is obtainable, and thus the determiner 150 determines that there is a warning necessary page.

Since the determiner 150 determines in step S15 that there is the warning necessary page, the warner 160 creates a warning message. The warning message created by the warner 160 includes a message that gives a warning for a difference or a possible difference of the specified text “525 yen” from the reasonable price in the electronic market. In addition, the warning message may include an estimated reasonable price that is “540 yen”. Still further, the warning message may be a message that simply appeals the necessity of changing the contents and the price.

Next, the warning promoter 160 adds an underline to the specified text or performs trimming on the image contents that contain such a specified text, thereby emphasizing and displaying, in the trading page, the specified text and the contents containing the specified text. Subsequently, the warning promoter 160 adds the created warning message to the trading page, and outputs, to the LAN card 106, the trading page which has a destination that is the terminal device 210 utilized by the store A, thereby giving a warning (step S16). Next, the warning promoter 160 ends the execution of the second warning process.

Subsequently, the LAN card 106 sends the trading page to which the warning message is added to the terminal device 210, and the terminal device 210 displays the received trading page on the display 219. Note that when the determiner 150 determines in step S15 that there is no warning necessary page, the determiner ends the process execution.

In this case, in the electronic market where a large number of stores are in business, the price at each store can be freely and easily checked, and thus the commercial product price set at each store often becomes a similar price, and a so-called reasonable price is settled in many cases. Accordingly, even if, for example, there are changes in the cost of raw materials and changes in the tax rate, the commercial product price and the tax-inclusive price often similarly change across the stores. Hence, the deleted text that contains the deleted frequency which is equal to or higher than the predetermined value is highly possibly different from the reasonable price after the raw material costs and the tax rate are changed.

Therefore, according to the above-explained structure, the warning device 100 gives a warning to the store that utilizes the trading page on which the related text with the deleted frequency equal to or higher than the predetermined value Th is posted in the electronic market, and thus an occurrence of a difference between the contents described in the trading page and the reasonable price in the electronic market can be suppressed.

### First Modified Example of Second Embodiment

In the second embodiment, an explanation was given of an example case in which the warning device 100 obtains, in step S11 of the second warning process illustrated in FIG. 8, the deleted texts from all trading pages of all stores. In addition, in the second embodiment, the explanation was given of an example case in which the warning device 100 counts the number of deleted texts for each group into which the deleted texts are classified, and calculates the deletion frequency obtained by dividing the counted value by the total number of all trading pages of all stores in step S12.

However, the present disclosure is not limited to those cases, and the warning device 100 may obtain the deleted texts from some of or all of the trading pages of some stores. In addition, the warning device 100 may calculate the deletion frequency obtained by dividing the counted value of the deleted texts by the total number of some of or all of the trading pages of some stores.

### Second Modified Example of Second Embodiment

The warning device 100 may store multiple predetermined values defined for each commercial product, calculate the deletion frequency for each commercial product, and give a warning to the store that utilizes the trading page on which the deleted text with a larger deletion frequency than the predetermined value defined for each commercial product is posted.

### Third Modified Example of Second Embodiment

The warning device 100 may store at least one search tag in association with the trading page, and may store multiple predetermined values defined for each search tag. The warning device 100 may calculate the deletion frequency for each search tag, and may give a warning to the store that utilizes the trading page on which the deleted text with a larger deletion frequency than the predetermined value defined for each search tag is posted.

### Fourth Modified Example of Second Embodiment

The warning device 100 according to this modified example calculates the deletion frequency for each category of the commercial product, and gives a warning to the store that utilizes the trading page on which the deleted text with a larger deletion frequency than the predetermine value defined for each category of the commercial product is posted.

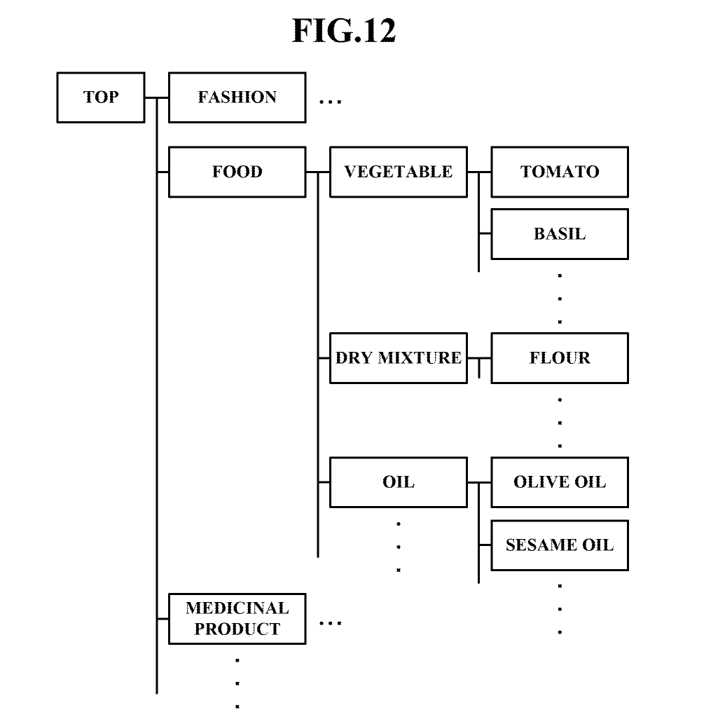

The category of a commercial product is the type of a commercial product, and the multiple categories construct a hierarchical structure as illustrated in FIG. 12. More specifically, a commercial product is classified into a category that is “fashion”, a category that is “food”, a category that is “medicinal product”, or other unillustrated categories. Example commercial products to be classified into the category “fashion” are European clothes, example commercial products to be classified into the category “food” are foods, and example commercial products to be classified into the category “medicinal product” are medicines.

In addition, the commercial product classified into the category “food” is further classified into a category “vegetable”, a category “dry mixture”, a category “oil”, or other unillustrated categories. Still further, the commercial product classified into the category “oil” is further classified into a category “olive oil”, a category “sesame oil”, or other unillustrated categories.

As explained above, the category “vegetable”, the category “dry mixture”, and the category “oil” construct the same layer. In addition, the lower layer thereof is constructed by the category “olive oil” and the category “sesame oil”.

The warning device 100 of this modified example employs substantially the same structure and performs substantially the same operation as those of the warning device 100 explained in the second embodiment. Hence, differences from the warning device 100 explained in the second embodiment will be explained below.

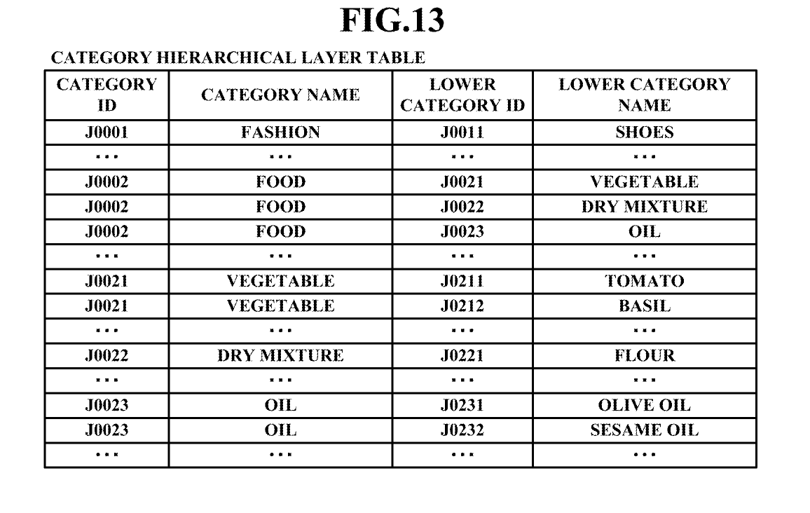

The information memory 190 of the warning device 100 illustrated in FIG. 9 stores a category hierarchical layer table illustrated in FIG. 13. The purpose of this is to calculate the deletion frequency based on the category hierarchical layer of a commercial product. The category hierarchical layer table contains information to identify a category (hereinafter, referred to as a category ID), information indicating the name of the category, a category ID of the closest lower category (hereinafter, referred to as a lower category) of the category, and information indicating the name of the lower category, in association with one another.

In addition, the information memory 190 stores the commercial product ID of a commercial product and the category ID of the lowest category into which the commercial product is classified in association with each other. Multiple commercial product IDs and category IDs are held in this example. Still further, the information memory 190 stores the category ID of the lowest category, and a predetermined value defined beforehand for the lowest category in association with each other. Multiple category IDs and the predetermined values are held in this case.

The warning device 100 executes the second warning process using the category hierarchical layer table. When the second warning process starts, the obtainer 120 in FIG. 9 obtains at least one lowest category ID from the category hierarchical table. The lowest category ID (hereinafter, lowest category ID) is a category ID that is not associated with the lower category ID.

Next, the obtainer 120 focuses on a lowest category ID not focused on yet among the searched multiple lowest category IDs. Subsequently, the obtainer 120 searches the commercial product ID that is associated with the focusing lowest category ID (hereinafter, referred to as a focusing category ID). Hence, the obtainer 120 specifies the commercial product ID of the commercial product (hereinafter, referred to as a focusing product) classified into the category (hereinafter, referred to as a focusing category) identified by the focusing category ID.

Subsequently, the obtainer 120 obtains (step S11) the deleted text associated with the deletion time and date between the current time and date and the predetermined time before the current time and date, and the commercial product ID of the focusing product.

Next, the calculator 170 classifies the obtained deleted texts, and counts the number of deleted texts for each group. Subsequently, the calculator 170 counts the number of URLs associated with the commercial product ID of the focusing product among the URLs of the trading pages contained in the trading price table. Hence, the calculator 170 counts the total number of trading pages of the focusing product. Next, the calculator 170 calculates (step S12) the deletion frequency obtained by dividing the counted value of the deleted texts by the counted value of the trading pages.

Next, the specifier 180 reads, from the information memory 190, the predetermined value Th associated with the category ID of the focusing category. Subsequently, the specifier 180 specifies (step S13) the group that has a larger deletion frequency than the predetermined value Th.

Next, the determiner 150 specifies the record that contains the added text which is any one of the deleted texts in the group specified by the specifier 180 (that is, the specified text). Subsequently, the determiner 150 specifies the record that contains the commercial product ID of the focusing product among the specified records, and obtains the URL contained in the specified record. The purpose of this is to specify the trading page which is for the focusing product, and on which the specified text is posted.

Next, the determiner 150 and the warner 160 respectively execute the processes from step S14 to step S16, thereby giving a warning when there is the warning necessary page. Subsequently, the warning device 100 repeats the processes from step S11 to step S16 until all lowest category IDs have been focused.

### Fifth Modified Example of Second Embodiment

The explanation was given of an example case in which the warning device 100 according to the fourth modified example of the second embodiment calculates the deletion frequency for each of the lowest categories. In addition, the warning device 100 according to the fourth modified example of the second embodiment determines the warning necessary page that is the trading page on which the deleted text with a larger deletion frequency than the predetermined value defined for each of the lowest categories is posted among the trading pages of the commercial product in the lowest category.

However, the present disclosure is not limited to this case, and the warning device 100 may calculate the deletion frequency for each of the highest or middle categories. In addition, the warning device 100 may determine the warning necessary page that is the trading page on which the deleted text with a larger deletion frequency than a predetermined value defined for each of the highest or middle categories among the trading pages of the commercial product in the highest or middle category.

### Sixth Modified Example of Second Embodiment

The explanation was given of an example case in which the warning device 100 according to the second modified example of the second embodiment stores multiple predetermined values defined for each commercial product, calculates the deletion frequency for each commercial product, and determines the warning necessary page on which the deleted text with a larger deletion frequency than the predetermined value defined for each commercial product is posted.

However, the present disclosure is not limited to such a case, and the warning device 100 may store multiple predetermined values for each consistent or similar commercial product group, calculate the deletion frequency for each consistent or similar commercial product group, and determine the warning necessary page on which the deleted text with a larger deletion frequency than the predetermined value defined for each consistent or similar commercial product group is posted. The consistent or similar commercial product group may be a group of commercial products classified in the same category, or may be a group of commercial products classified in the closest common higher category.

### Seventh Modified Example of Second Embodiment

The explanation was given of an example case in which the warning device 100 according the fourth modified example of the second embodiment calculates the deletion frequency for each category, and determines the warning necessary page that is the trading page on which the deleted text with a larger deletion frequency than the predetermined value defined for each category is posted.

However, the present disclosure is not limited to this case, and the warning device 100 may calculate the deletion frequency for each consistent or similar category, and may determine the warning necessary page that is the trading page on which the deleted text with a larger deletion frequency than the predetermined value defined for each consistent or similar category is posted. The same or similar categories may be, for example, the categories that have the closest common higher category.

### Eighth Modified Example of Second Embodiment

In the second embodiment and the several modified examples thereof, the explanation was given of an example case in which the warning device 100 executes the first warning process to extract the related text from the trading page, and gives a warning when determining that there is a contradiction between the extracted related text and the price. In addition, in the second embodiment and the several modified examples thereof, the explanation was given of an example case in which the warning device 100 specifies the related text with the deletion frequency that is equal to or larger than the predetermined value in the electronic market, and gives a warning when the specified related text is posted on the trading page.

However, the present disclosure is not limited to this case, and the warning device 100 may execute the second warning process, and give a warning when the related text with the deletion frequency that is equal to or larger than the predetermined value is posted on the trading page, but may omit the execution of all of or some of the first warning process, and give no warning when there is a contradiction between the related text on the trading page and the price.

### Third Embodiment

In a third embodiment of the present disclosure, an explanation will be given of an example case in which the related text includes a text relevant to an applied time period at which the changed price is applied for trading. A warning system according to the third embodiment determines whether or not the posted contents of the trading page is causing a contradiction based on a time and date (hereinafter, referred to as a price changed time and date) at which the price is changed, and the applied time period of the changed price, and gives a warning when determining that there is the contradiction.

The warning system 1 of this embodiment employs substantially the same structure, as those of the warning systems 1 explained in the first and second embodiments and in the several modified examples of the first and second embodiments, has substantially the same operations, and has substantially the same functions. Hence, a difference between the warning system 1 of this embodiment and the warning systems 1 explained in the first and second embodiments and the several modified examples of the first and second embodiments will be explained.

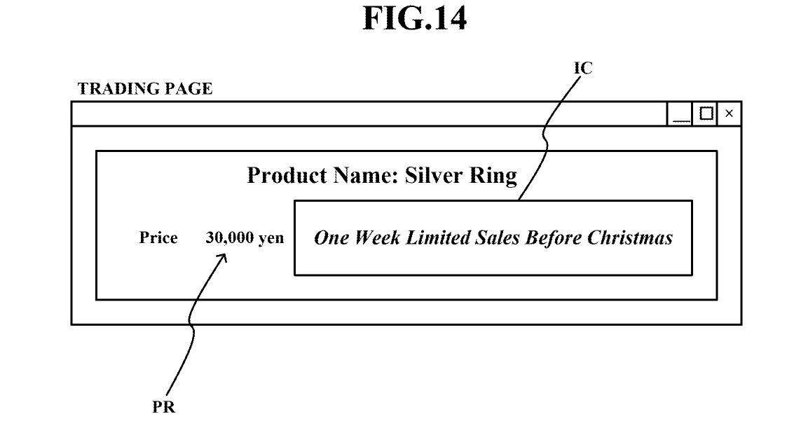

In this embodiment, as illustrated in FIG. 14, an explanation will be given of an example case in which an image that contains texts “Christmas” and “only one week” indicating the time period at which the changed price is applied for trading is posted in the image contents display part IC of the trading page.

In this embodiment, the trading price table stored in the information memory 190 contains information indicating the price changed time and date, and the related text posted on the trading page in association with the store ID, the commercial product ID, information indicating the changed price, the URL of the trading page, and the like. Multiple pieces of information indicating the price changed times and dates, and related texts are held in this case.

In this embodiment, the warning device 100 executes the first warning process illustrated in FIG. 4 using the trading price table that contains information indicating the price changed time and date. When starting the first warning process, the warning device 100 executes the processes from step S01 to step S03, thereby updating information indicating the changed price and contained in the trading price table. Next, the updater 130 of the warning device 100 obtains the current time and date from the OS, and specifies the price changed time and date based on the obtained time and date. Subsequently, information indicating the price changed time and date is put in the trading price table in association with information indicating the updated changed price.

Note that the price changed time and date is not limited to the time and date at which the information indicating the changed price in the trading price table is changed, and may be a time and date at which the information indicating the changed price is received or obtained, or, a time and date at which the trading page on which the changed price is posted is made available to the public.

Next, the warning device 100 executes the processes from step S04 to step S06. Subsequently, the updater 130 of the warning device 100 puts the text (hereinafter, referred to as a time related text) relevant to the applied time period at which the changed price is applied for trading among the related texts extracted in step S06 in the trading price table in association with the information indicating the changed price updated in step S03.

Next, the warning device 100 executes the processes in steps S07 and S08, and then ends the first warning process.

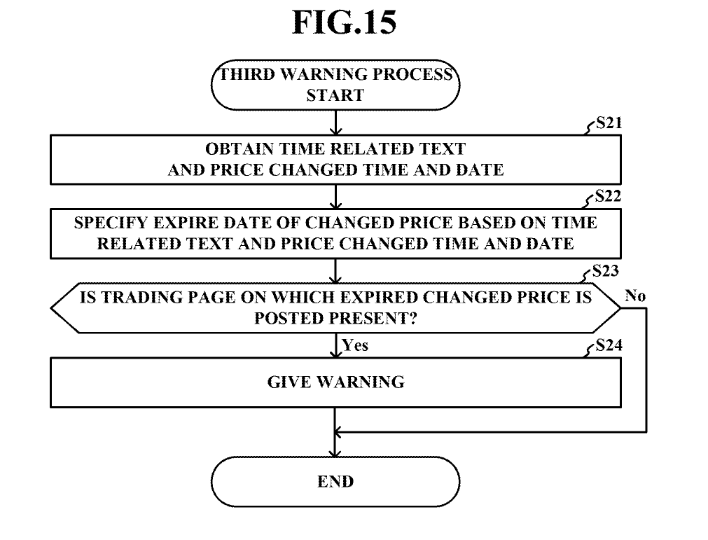

In this embodiment, the CPU 101 in FIG. 3 executes a third warning process illustrated in FIG. 15 using the trading price table that contains the information indicating the price changed time and date and the time related text when a predetermined time has come. The third warning process is a process of giving a warning when the time period at which the changed price is applied has elapsed.

When the third warning process starts, the obtainer 120 obtains (step S21) at least one combination of the time related text and information indicating the price changed time and date from the trading price table.

Next, the determiner 150 specifies (step S22) an expiration date of the changed price for each combination of the time related text and the information indicating the price changed time and date. When, for example, the time related text is “before Christmas”, the determiner 150 obtains the current time and date from the OS, and specifies a preceding day of Christmas that will come within a six months from the obtained time and date or has already come as the expiration date. In addition, when, for example, the time related text is “one week limited”, the determiner 150 determines the time and date that is one week after the price changed time and date as the expiration date.

Next, the determiner 150 determines, for each specified expiration date, whether or not the time period has elapsed based on the time and date obtained from the OS, thereby determining (step S23) whether or not there is a trading page that has a contradiction in the posted contents. The trading page that has a contradiction in the posted contents is a page on which the changed price with an elapsed expiration date and defined by the time related text is still posted.

Conversely, when determining that none of the expiration dates have elapsed yet, the determiner 150 determines that there is no trading page on which the expired changed price is posted. In contrast, when determining that any of the expiration dates have already elapsed, the determiner specifies the trading page on which the time related text which defines the elapsed expiration date and the changed price are still posted.

When the determiner 150 determines in step S23 that there is a trading page on which the expired changed price is still posted, the warner 160 creates a warning message. The warning message to be created by the warner 160 contains the time related text, the expiration date of the changed price defined by the time related text, and a sentence that gives a warning for an expiration.

Next, the warning promoter 160 adds an underline to the time related text or performs trimming on the image contents that contain such a time related text, thereby emphasizing and displaying the time related text, and the like. Subsequently, the warning promoter 160 adds the created warning message to the trading page, and outputs, to the LAN card 106, the trading page which has a destination that is the terminal device 210 utilized by the store, thereby giving a warning (step S16). Next, the warning promoter 160 ends the execution of the third warning process.

According to this structure, the warning device 100 gives a warning to the store that utilizes the trading page on which the expired changed price is still posted when the expiration date of the changed price defined based on the time related text has already elapsed. Hence, the warning device 100 prevents an expired changed price from still being posted on the trading page.

The first to third embodiments and the several modified examples thereof can be combined with one another. The warning device 100 that employs a structure to accomplish the functions of any of the first to third embodiments and the several modified examples thereof can be provided, and a system constructed by multiple devices, and employing, as a whole, a structure to accomplish the functions of any of the first to third embodiments and the several modified examples thereof can also be provided.

The warning device 100 that employs a structure beforehand to accomplish the functions of any of the first to third embodiments and the several modified examples thereof can be provided, and by applying a program, a conventional device 100 becomes able to function as the warning device 100 according to any of the first to third embodiments and the several modified examples thereof. That is, by applying a program to accomplish the respective functional structures of the warning devices 100 exemplified in the first to third embodiments and the several modified examples thereof in a manner allowing a computer (for example, a CPU) that controls a conventional device to execute the program, such a device becomes able to function as the warning device 100 according to any of the first to third embodiments and the several modified examples thereof.

How to distribute such a program is optional. For example, the program can be distributed in a manner stored in a non-transitory recording medium, such as a memory card, a CD-ROM, or a DVD-ROM, or may be distributed via a non-transitory communication medium like the Internet. In addition, a searching method according to the present disclosure can be carried out using the warning device 100 according to any of the first to third embodiments and the several modified examples thereof.

Several preferred embodiments of the present disclosure were explained in detail, but the present disclosure is not limited to any particular embodiment, and various changes and modifications can be made thereto within the scope and spirit of the present disclosure.

In addition, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

10 Communication network
100 Warning device
101 CPU
102 ROM
103 RAM
104 Hard disk
105 Media controller
106 LAN card
107 Video card
108 LCD
109 Keyboard
110 Speaker
111 Touch pad
120 Obtainer
130 Updater
140 Extractor
150 Determiner
160 Warner
170 Calculator
180 Specifier
190 Information memory
210, 220 Terminal device
211, 221 Input hardware
219, 229 Display

1-9. (canceled)

10. A warning device comprising:
an extractor that extracts a related text relevant to a price of a trading object from a web page for trading the trading object when the trading price of the trading object is changed in an electronic market where a large number of stores are in business;
a specifier that specifies a related text for which a frequency of replacement or deletion from the web pages in the extracted related text is equal to or larger than a predetermined value;
a determiner that determines that a difference between a price relevant to the extracted related text and a market price formed in the electronic market arises, if the specified related text is displayed on the web page where the related text is extracted; and
a warner that warns when the determiner determines that the difference has arisen.

11. A warning device comprising:
an extractor that extracts a related text relevant to a price of a trading object from a web page for trading the trading object when the trading price of the trading object is changed;
a determiner that determines whether or not there is a contradiction between the extracted related text and the changed price; and
a warner that warns when the determiner determines that there is the contradiction,
wherein the related text is further relevant to an applied time period at which the changed price is being applied to the trading,
the determiner further determines whether or not there is a contradiction in a content displayed on the web page based on a time and date at which the price was changed and the applied time period, and
the warner warns when the determiner determines that there is the contradiction.

12. A warning device comprising:
an extractor that extracts a related text relevant to a price of a trading object from a web page for trading the trading object when the trading price of the trading object is changed;
a determiner that determines whether or not there is a contradiction between the extracted related text and the changed price; and
a warner that warns when the determiner determines that there is the contradiction,
wherein the related text is a text indicating a price previous to the change, a text indicating a difference between the price previous to the change and the changed price, or a text implying the price previous to the change,
the warning device further comprises an information memory that stores the price of the trading object previous to the change, and
the determiner determines whether or not there is the contradiction based on the price previous to the change specified on a basis of the related text, and the stored price previous to the change.

13. The warning device according to claim 11 further comprising a specifier that specifies a related text for which a frequency of replacement or deletion from web pages used for trading in an electronic market where a large number of stores are in business is equal to or larger than a predetermined value,
wherein the warner warns when the specified related text is displayed on the web page.

14. The warning device according to claim 12 further comprising a specifier that specifies a related text for which a frequency of replacement or deletion from web pages used for trading in an electronic market where a large number of stores are in business is equal to or larger than a predetermined value,
wherein the warner warns when the specified related text is displayed on the web page.

15. The warning device according to claim 10, wherein the extractor extracts the related text from an image displayed on the web page.

16. The warning device according to claim 11, wherein the extractor extracts the related text from an image displayed on the web page.

17. The warning device according to claim 12, wherein the extractor extracts the related text from an image displayed on the web page.

18. The warning device according to claim 10, wherein the trading price includes the price of the trading object and a delivery charge for the trading object.

19. The warning device according to claim 11, wherein the trading price includes the price of the trading object and a delivery charge for the trading object.

20. The warning device according to claim 12, wherein the trading price includes the price of the trading object and a delivery charge for the trading object.

21. The warning device according to claim 13, wherein the trading price includes the price of the trading object and a delivery charge for the trading object.

22. The warning device according to claim 14, wherein the trading price includes the price of the trading object and a delivery charge for the trading object.

23. The warning device according to claim 15, wherein the trading price includes the price of the trading object and a delivery charge for the trading object.

24. The warning device according to claim 16, wherein the trading price includes the price of the trading object and a delivery charge for the trading object.

25. The warning device according to claim 17, wherein the trading price includes the price of the trading object and a delivery charge for the trading object.

26. A non-transitory computer-readable recording medium having recorded therein a program that causes a computer to function as:
an extractor that extracts a related text relevant to a price of a trading object from a web page for trading the trading object when the trading price of the trading object is changed in an electronic market where a large number of stores are in business;
a specifier that specifies a related text for which a frequency of replacement or deletion from the web pages in the extracted related text is equal to or larger than a predetermined value;
a determiner that determines that a difference between a price relevant to the extracted related text and a market price formed in the electronic market arises, if the specified related text is displayed on the web page where the related text is extracted; and
a warner that warns when the determiner determines that the difference has arisen.

27. A warning method comprising:
an extracting step where a warning device extracts a related text relevant to a price of a trading object from a web page for trading the trading object when the trading price of the trading object is changed in an electronic market where a large number of stores are in business;
a specifying step where the warning device specifies a related text for which a frequency of replacement or deletion from the web page in the extracted related text is equal to or larger than a predetermined value;
a determining step where the warning device determines that a difference between a price relevant to the extracted related text and a market price formed in the electronic market arises, if the specified related text is displayed on the web page where the related text is extracted; and
a warning step where the warning device warns when the determiner determines that the difference has arisen.
